(19) United States
(12) Patent Application Publication
(10) Pub. No.: US 2021/0182781 A1
(43) Pub. Date: Jun. 17, 2021

(54) INFORMATION PROCESSING APPARATUS, INFORMATION PROCESSING METHOD, AND PROGRAM

(71) Applicant: SONY CORPORATION, Tokyo (JP)

(72) Inventors: Haruto TAKEDA, Tokyo (JP); Masashi OOKUBO, Kanagawa (JP); Tomohisa TAKAOKA, Kanagawa (JP); Naofumi FUKASAWA, Tokyo (JP)

(73) Assignee: SONY CORPORATION, Tokyo (JP)

(21) Appl. No.: 17/052,647

(22) PCT Filed: Mar. 15, 2019
(86) PCT No.: PCT/JP2019/011017

§ 371 Date: Nov. 3, 2020

(30) Foreign Application Priority Data
May 10, 2018 (JP) 2018-091281

(51) Int. Cl. G06Q 10/08; G06N 5/04

(52) U.S. Cl. CPC G06Q 10/0833; G06N 5/04

(57) ABSTRACT

There is provided an information processing apparatus, information processing method, and program that make it possible to further reduce a load relating to delivery. The information processing apparatus includes a generation unit that generates, on a basis of delivery object information related to a delivery object that is to be delivered to a user and user information related to the user, receiving method information related to a receiving method of the delivery object.

### TECHNICAL FIELD

The present disclosure relates to an information processing apparatus, an information processing method, and a program.

### BACKGROUND ART

In recent years, delivery to individuals has been increasing due to an influence of the spread of Internet shopping, etc. In a case of delivery to an individual, it is often the case that a delivery destination user (hereinafter, also simply referred to as a user) is unable to receive the delivery because he/she is not at home. Locker-type equipment (also called a delivery box, a delivery locker, etc.) that makes it possible for the user to receive a delivery object even when the user is not at home is also utilized, but residences and places that are available for the locker-type equipment are limited. Therefore, in a case where the user is not at home, a delivery person often performs redelivery to the user. As described above, in a case where the user is not at home and is unable to receive the delivery object, not only is a load on a delivery company or the delivery person increased due to the redelivery to be performed, but a load on the user may also be increased due to a request or an adjustment of the redelivery to be performed.

Incidentally, recognition of actions of a user is performed by using a terminal possessed by the user. For example, the following Patent Literature 1 discloses a technology of recognizing actions of a user on the basis of an output of a sensor built in a mobile phone possessed by the user and predicting an arrival time of the user to a predetermined destination one the basis of information of the recognized action.

### CITATION LIST

### Patent Literature

Patent Literature 1: Japanese Unexamined Patent Application Publication No. 2009-118513

### SUMMARY OF THE INVENTION

### Problems to be Solved by the Invention

If the above-described technology of predicting an arrival time of a user is used for delivery work, for example, delivering a delivery object to a destination of the user in accordance with a predicted arrival time of the user may reduce a load on a delivery person and the user. However, even if the user receives the delivery object, it may be difficult for the user to take it home, depending on a state of the user, a size of the delivery object, etc., and the load may not be sufficiently reduced.

Accordingly, the present disclosure proposes a novel and improved information processing apparatus, information processing method, and program that make it possible to further reduce a load relating to delivery.

### Means for Solving Problem

According to the present disclosure, there is provided an information processing apparatus including a generation unit that generates, on a basis of delivery object information related to a delivery object that is to be delivered to a user and user information related to the user, receiving method information related to a receiving method of the delivery object.

Furthermore, according to the present disclosure, there is provided an information processing method including generating, by a processor, on a basis of delivery object information related to a delivery object that is to be delivered to a user and user information related to the user, receiving method information related to a receiving method of the delivery object.

Furthermore, according to the present disclosure, there is provided a program for causing a computer to achieve a function of generating, on a basis of delivery object information related to a delivery object that is to be delivered to a user and user information related to the user, receiving method information related to a receiving method of the delivery object.

### Effect of Invention

As described above, the present disclosure makes it possible to further reduce a load relating to delivery.

Note that the above-described effect is not necessarily limited, and in addition to or in place of the above-described effect, it may be possible to achieve any of effects described in the present specification or other effects that may be understood from the present specification.

### BRIEF DESCRIPTION OF DRAWING

FIG. 1 is a diagram that illustrates a schematic configuration of an information processing system according to an embodiment of the present disclosure.

FIG. 2 is a sequence diagram that illustrates a schematic operation of the information processing system according to the present embodiment.

FIG. 3 is a block diagram that illustrates a configuration example of a user terminal 1.

FIG. 4 is a block diagram that illustrates a configuration example of a server 2.

FIG. 5 is a block diagram that illustrates a functional configuration of a generation unit 21.

FIG. 6 is an explanatory diagram for describing an example of a method of predicting whether or not a user currently has luggage.

FIG. 7 is a sequence diagram that illustrates an example of an operation of the information processing system according to the present embodiment.

FIG. 8 is a sequence diagram that illustrates another operation example of the information processing system according to the present embodiment.

FIG. 9 is a sequence diagram that illustrates another operation example of the information processing system according to the present embodiment.

FIG. 10 is a diagram that illustrates an example of a user interface in which pieces of receiving method information respectively corresponding to a plurality of receiving method candidates are presented.

FIG. 11 is a diagram that illustrates an example of a user interface that displays a receiving position on a map.

FIG. 12 is a diagram that illustrates an example of a user interface that suggests a change to a receiving method of receiving a delivery object that is desired to be received quickly.

FIG. 13 is a diagram that illustrates an example of a user interface for re-adjusting the receiving method in a case where an action of the user is different from a schedule.

FIG. 14 is a block diagram that illustrates a configuration example of a user terminal 1-2 according to a present modification example.

FIG. 15 is an explanatory diagram that illustrates a hardware configuration example.

### MODES FOR CARRYING OUT THE INVENTION

Hereinafter, preferred embodiments of the present disclosure will be described in detail with reference to the accompanying drawings. Note that, in the present specification and the drawings, constituent elements having substantially the same functional configuration are assigned by the same reference numerals to omit duplicate descriptions.

Furthermore, in the present specification and the drawings, a plurality of constituent elements having substantially the same functional configuration may be distinguished by adding different alphabets after the same reference numeral. However, in a case where it is not necessary to particularly distinguish each of the plurality of constituent elements having substantially the same functional configuration, only the same reference numeral is assigned.

Note that the description is made in the following order.
<<1. Outline>>
<<2. Configuration>>
<<3. Operation Examples>>
<<4. Specific Examples of User Interface>>
<<5. Modification Examples>>
<<6. Hardware Configuration Example>>
<<7. Summary>>

### 1. Outline

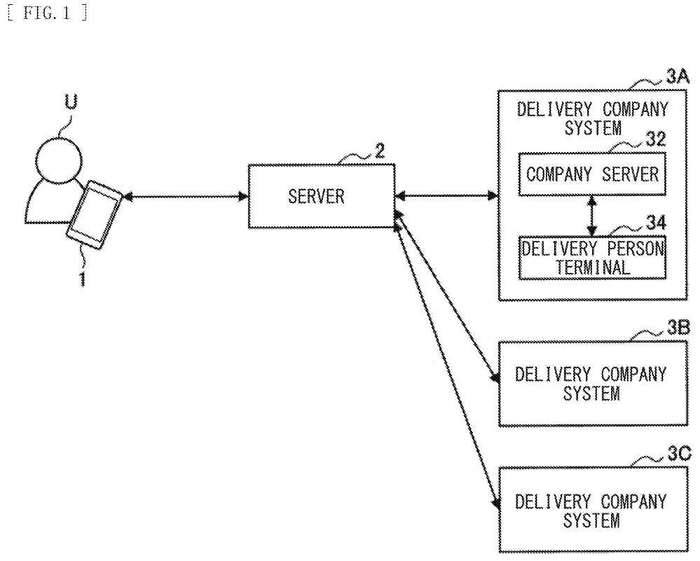

First, an outline of an embodiment of the present disclosure will be described with reference to the drawings. FIG. 1 is a diagram that illustrates a schematic configuration of an information processing system according to an embodiment of the present disclosure. As illustrated in FIG. 1, the information processing system according to the present embodiment includes a user terminal 1, a server 2, and delivery company systems 3A to 3C.

The user terminal 1 is an information processing apparatus that is used by a user. Although FIG. 1 illustrates an example in which the user terminal 1 is a smartphone possessed by a user U, the user terminal 1 is not limited to such an example, and the user terminal 1 may be a PC (Personal Computer), a tablet device, a clock device, an HMD (Head Mounted Display), an in-vehicle terminal, etc. such as a car navigation device, etc. Note that although FIG. 1 illustrates only one user terminal 1, there may be a plurality of user terminals 1 depending on the number of users.

The server 2 communicates with the user terminal 1 and the delivery company systems 3A to 3C via a network (not illustrated) and provides a service to the user U who uses the user terminal 1. The server 2 according to the present embodiment makes it possible to provide the user U with a function as agent software (hereinafter, also referred to as a receiving agent) that performs communications related to reception of a delivery object with the delivery company systems 3A to 3C on behalf of the user U.

The delivery company systems 3A to 3C are systems for performing management related to delivery such as a delivery object, a delivery status, a delivery schedule, etc. The delivery company systems 3A to 3C are respectively used by different delivery companies. Note that, hereinafter, the delivery company systems 3A to 3C are each simply referred to as a delivery company system 3 in a case where it is not necessary to particularly distinguish the delivery company systems 3A to 3C. Although FIG. 1 illustrates three delivery company systems 3A to 3C as the delivery company systems 3, the number of delivery company systems 3 (i.e., the number of delivery companies) to which the server 2 is couplable may be one or two, or more than three.

Although a configuration of the delivery company system 3 may vary depending on a delivery company, a configuration example of the delivery company system 3A illustrated in FIG. 1 will be described here as an example. The delivery company system 3A illustrated in FIG. 1 includes a company server 32 and a delivery person terminal 34, and the company server 32 and the delivery person terminal 34 are coupled to each other via the network, which is not illustrated.

The company server 32 is a server that performs management related to a delivery object, a delivery status (before shipping, shipped, during delivery, etc.), a delivery schedule, and the like of a delivery company that uses the delivery company system 3A. The company server 32 provides (transmits) information related to the delivery object (hereinafter, also referred to as delivery object information) and information related to the delivery schedule (hereinafter, also referred to as delivery schedule information) to the delivery person terminal 34 possessed by a delivery person who performs delivery of the delivery object and acquires (receives) information related to the delivery status (hereinafter, also referred to as delivery status information) from the delivery person terminal 34.

Furthermore, the company server 32 provides the server 2 with the delivery object information, the delivery status information, and the delivery schedule information, etc. in response to an inquiry from the server 2. In addition, the company server 32 arranges delivery and changes the delivery schedule in response to a change request of a receiving method from the server 2. Note that, in a case where the delivery schedule is changed, the company server 32 may provide the delivery person terminal 34 with arrangement information indicating that the delivery is arranged in response to the change request of the receiving method.

The delivery person terminal 34 is an information processing terminal possessed by the delivery person (for example, a driver of a delivery truck, etc.) who delivers the delivery object to the user. The delivery person terminal 34 may be a portable terminal such as a smartphone or a tablet device, or may be an in-vehicle terminal such as a car navigation device, etc., provided in a vehicle (e.g., a delivery truck).

The delivery person terminal 34 acquires (receives) information of the delivery schedule from the company server 32 and presents the information to the delivery person. Furthermore, the delivery person terminal 34 transmits information related to the delivery status acquired on the basis of sensing performed by a position sensor included in the delivery person terminal 34 or an input by the delivery person to the company server 32. Note that, although FIG. 1 illustrates only the single delivery person terminal 34, there may be a plurality of delivery person terminals 34 depending on the number of delivery persons.

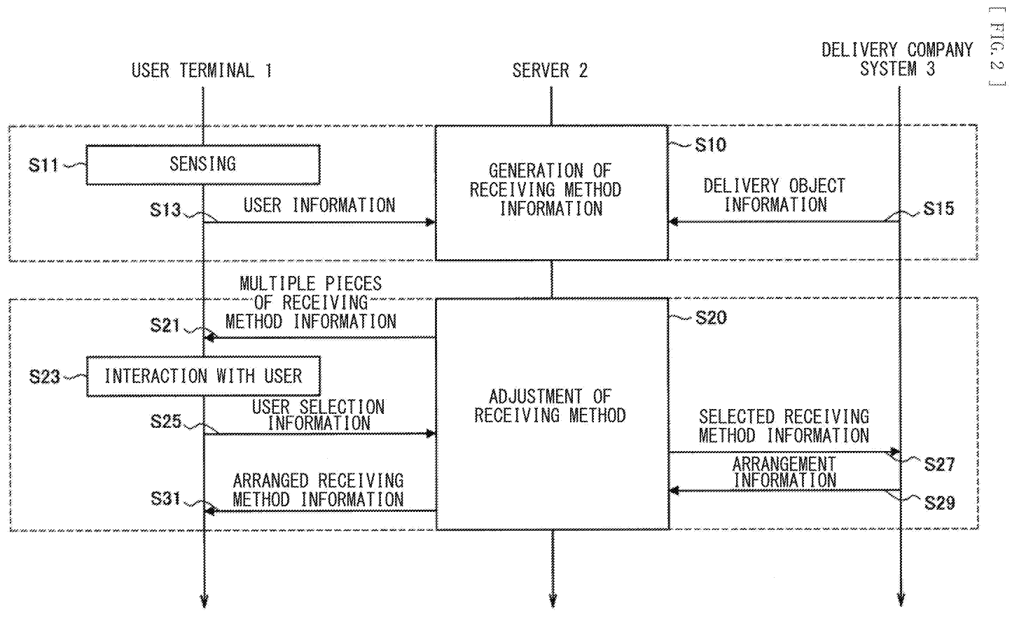

In the above, the schematic configuration of the information processing system according to the present embodiment has been described. Subsequently, a schematic operation of the above-described information processing system according to the present embodiment will be described. FIG. 2 is a sequence diagram that illustrates a schematic operation of the information processing system according to the present embodiment.

As illustrated in FIG. 2, upon overviewing an operation of the information processing system according to the present embodiment, the operation includes step S10 for the server 2 to perform generation of the receiving method information and step S20 for the server 2 to perform adjustment of the receiving method.

In step S10, first, a sensor included in the user terminal 1 performs sensing for acquiring information related to the user (hereinafter, also referred to as user information) (S11). Then, the user information acquired in step S11 is transmitted from the user terminal 1 to the server 2. Note that the user information transmitted in step S13 may include not only the information acquired by sensing in step S11, such as current user position information and the like, but also information that is inputted to or stored in the user terminal 1, such as schedule information and planned route information, etc. of the user. Details of the user information will be described later.

On the other hand, the server 2 receives the delivery object information related to the delivery object from the delivery company system 3 (S15). Details of the delivery object information will be described later. Then, the server 2 generates the receiving method information related to the receiving method of the delivery object on the basis of the user information received in step S13 and the delivery object information received in step S15. Note that in a case where there is a plurality of receiving method candidates, the server 2 may generate a plurality of pieces of receiving method information corresponding to the plurality of receiving method candidates in step S10. Furthermore, although details of the receiving method information will be described later, the receiving method information includes at least information of a receiving position and information of a receiving time.

In the above, step S10 for the server 2 to perform generation of the receiving method information has been described. Subsequently, step S20 for the server 2 to perform adjustment of the receiving method will be described. In step S20, the server 2 first transmits the plurality of pieces of receiving method information corresponding to the plurality of receiving method candidates generated in step S10 to the user terminal 1 (S21). Subsequently, through interaction between the user terminal 1 and the user, a single receiving method is selected from the plurality of receiving method candidates (S23). Then, information related to the selection by the user (hereinafter, also referred to as user selection information) in step S23 is transmitted from the user terminal 1 to the server 2 (S25).

Then, receiving method information corresponding to the receiving method selected by the user in step S23 is provided (transmitted) from the server 2 to the delivery company system 3 (S27). The delivery company system 3 performs an arrangement of delivery (change of delivery schedule, etc.) according to the received receiving method information, and transmits arrangement information indicating that the delivery is arranged according to the receiving method information to the server 2 (S29). Then, the server 2 transmits receiving method information corresponding to the arranged delivery schedule to the user terminal 1 (S31), making it possible for the user to confirm the currently scheduled (arranged) receiving method.

In the above, the schematic operation of the information processing system according to the present embodiment has been described. Note that FIG. 2 illustrates a schematic operation, and the information processing system according to the present embodiment may of course perform processing not illustrated in FIG. 2.

### 2. Configuration

In the above, the outline of the present embodiment has been described. Subsequently, more detailed configurations of the user terminal 1 and the server 2 according to the above-described present embodiment will be sequentially described.

<2-1. User Terminal>

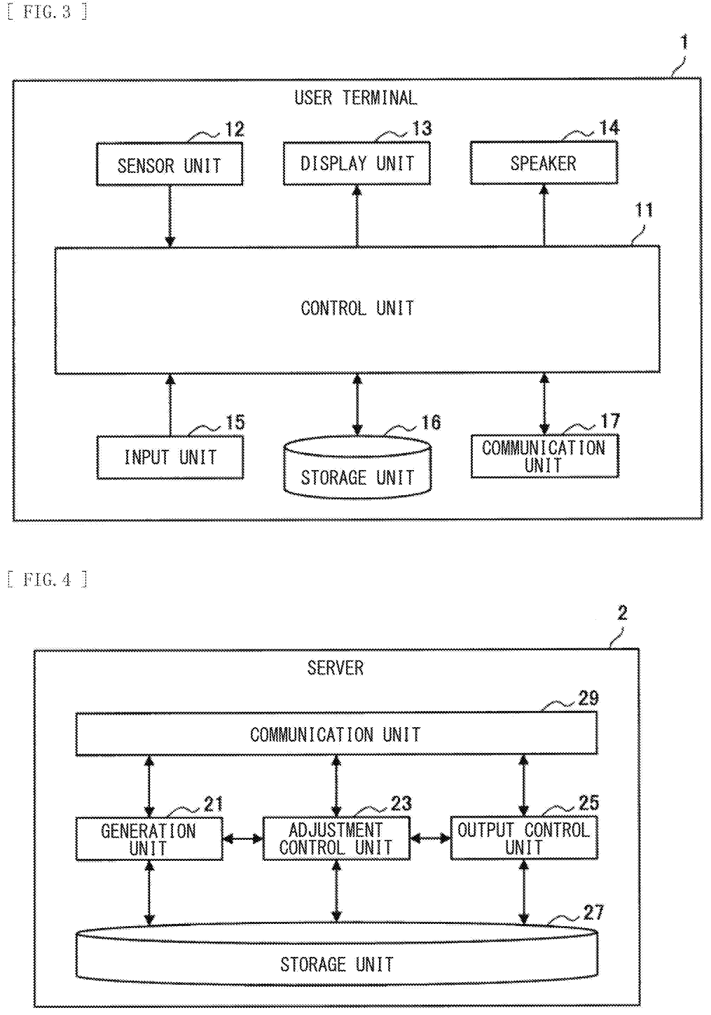

FIG. 3 is a block diagram that illustrates a configuration example of the user terminal 1. As illustrated in FIG. 3, the user terminal 1 is the information processing apparatus that includes a control unit 11, a sensor unit 12, a display unit 13, a speaker 14, an input unit 15, a storage unit 16, and a communication unit 17.

The control unit 11 controls each configuration included in the user terminal 1. For example, the control unit 11 controls the display unit 13, the speaker 14, or an unillustrated vibration unit, according to output control information received from the server 2 to be described later, via the communication unit 17, to present various kinds of information. Furthermore, the control unit 11 controls the communication unit 17 to transmit, to the server 2, information acquired by sensing performed by the sensor unit 12, information inputted via the input unit 15 (the user information and the user selection information), or the user information, etc. stored in the storage unit 16. Note that the control unit 11 may periodically transmit the user information acquired by sensing performed by the sensor unit 12 or the user information inputted by the user to the server 2, or that the control unit 11 may cause the user information to be transmitted to the server 2 in response to a request from the server 2, a shipping notification of a delivery object, or the like.

The sensor unit 12 includes various sensors such as a position sensor, an acceleration sensor, a gyro sensor, a geomagnetic sensor, an optical sensor, a sound sensor, a distance sensor, and a force sensor. The sensor unit 12 acquires, by performing sensing, information related to the user of the user terminal 1 or surroundings of the user. The user information acquired by the sensor unit 12 may include, for example, the current position information of the user, acceleration information of the user, posture information of the user, and the like.

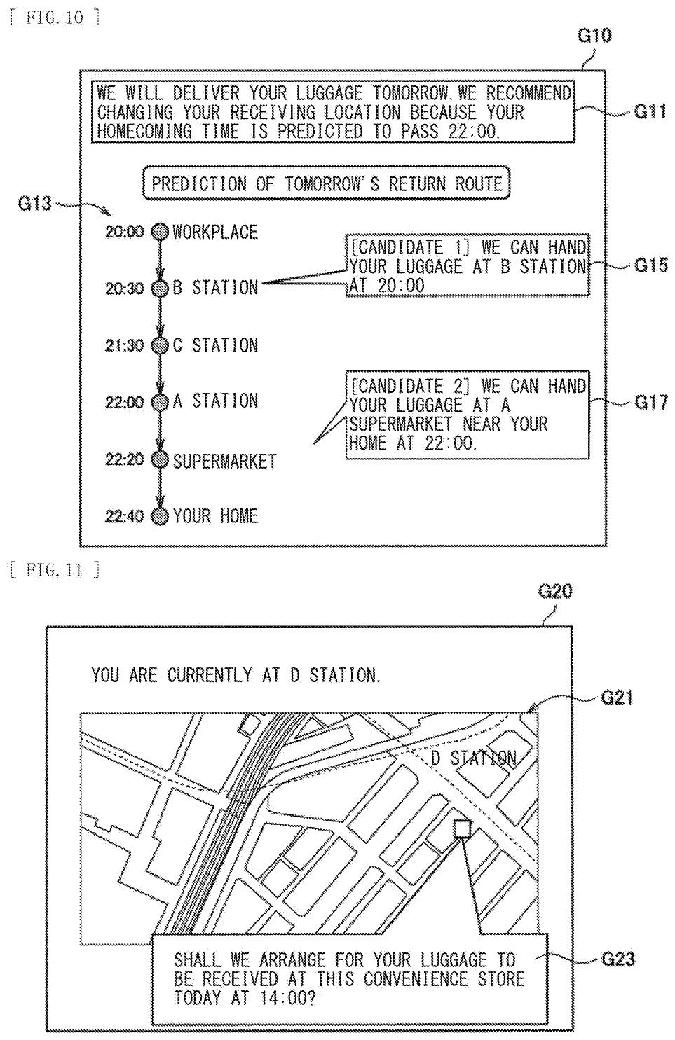

The display unit 13 is a display that displays a user interface (screen). The user interface presents various information according to the control of the control unit 11. Examples of the user interface displayed on the display unit 13 will be described later with reference to FIGS. 10 to 13.

The speaker 14 performs sound output according to the control of the control unit 11. The speaker 14 may present various information by voice output.

The input unit 15 is achieved by a device by which the user inputs information, such as a mouse, a keyboard, a touch panel, a button, a microphone, a switch, and a lever. Note that the input unit 15 may be achieved as a touch panel display integrated with the display unit 13.

The storage unit 16 stores programs and data used for operation of the user terminal 1. For example, the storage unit 16 may store the user information such as the schedule information of the user.

The communication unit 17 is a communication module for transmitting and receiving data to/from another device (e.g., the server 2) by wired or wireless communication according to the control of the control unit 11. The communication unit 17 wirelessly communicates with an external device directly or via a network access point by a communication scheme such as wired LAN (Local Area Network), wireless LAN, Wi-Fi (Wireless Fidelity, registered trademark), infrared communication, Bluetooth (registered trademark), or near-field/non-contact communication.

<2-2. Server>

FIG. 4 is a block diagram that illustrates a configuration example of the server 2. As illustrated in FIG. 4, the server 2 is the information processing apparatus that includes a generation unit 21, an adjustment control unit 23, an output control unit 25, a storage unit 27, and a communication unit 29. Of functions of the server 2, a function as the receiving agent is achieved by functions of the generation unit 21, the adjustment control unit 23, and the output control unit 25.

The generation unit 21 generates the receiving method information related to the reception of the delivery object on the basis of the user information provided by the user terminal 1 and the delivery object information provided by the delivery company system 3.

The user information may include, for example, the position information indicating the current position of the user (the position information of the user terminal 1), the schedule information of the user, and the planned route information, etc. related to a planned movement route of the user as described above. Note that the user information is not limited to the examples described above, and may include various types of information related to the user. For example, various sensor data acquired by the sensor unit 12 of the user terminal 1 and various information related to the user estimated on the basis of the sensor data (information indicating a current state of the user, etc.) may be used as the user information in the generation unit 21.

Furthermore, the delivery object information may include, for example, information indicating whether or not the delivery object is a mail-order item, information related to a type of the delivery object (home electric appliances, tableware, electronic components, etc.), information related to a size of the delivery object, information related to a weight of the delivery object, information related to a storage method of the delivery object, information related to a sender of the delivery object, information indicating a current position of the delivery object, information as to whether or not the user wishes to quickly receive the delivery object, information indicating when the delivery object will be used, information indicating where the delivery object will be used, and the like. The information related to the size and weight of the delivery object may include information of a specific size and weight, or it may be information such as an item that has to be carried by car, an item that it is not possible to be carried by hand, an item that can be contained in a bag, and the like. The information related to a storage method of the delivery object may be, for example, information indicating whether or not the delivery object has to be frozen. Note that the delivery object information may include not only information provided by the delivery company system 3 but also information related to the delivery object estimated on the basis of information provided by the delivery company system 3.

Furthermore, the receiving method information generated by the generation unit 21 includes receiving time information related to a time at which the user is able to receive the delivery object and receiving position information related to a position where the user is able to receive the delivery object. Note that the receiving time information may be information indicating a single time, information including a start time and an end time, or information indicating a date. Furthermore, the receiving position information may be information including latitude and longitude, or information indicating a specific place (e.g., a home and a workplace of the user, stores such as convenience stores, stations, etc.).

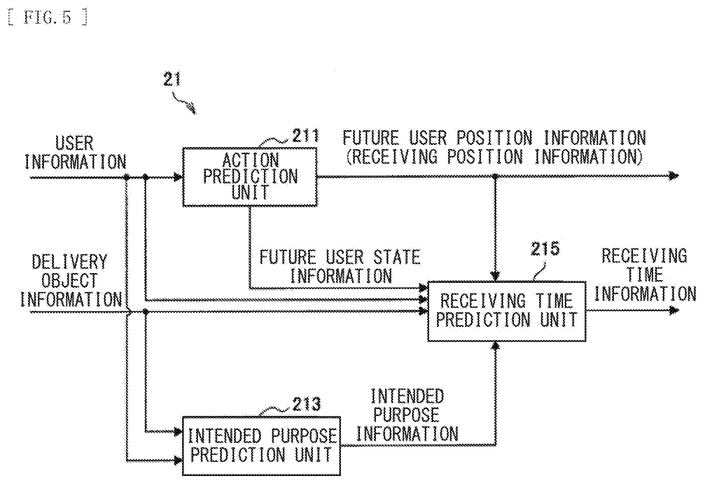

Detailed functional configuration of the generation unit 21 will be described with reference to FIG. 5. FIG. 5 is a block diagram that illustrates a functional configuration of the generation unit 21. Referring to FIG. 5, the generation unit 21 includes functions as an action prediction unit 211, an intended purpose prediction unit 213, and a receiving time prediction unit 215.

The action prediction unit 211 predicts a future user position and a future user state on the basis of the user information. The action prediction unit 211 may perform such prediction by machine learning. For example, the action prediction unit 211 may predict a future user position and a future user state by using a predictor obtained by learning learning data including past user information and the like.

The action prediction unit 211 generates information indicating a position of the user in the future (future user position information) by predicting the future user position. The future user position information may be generated in association with future time information. With this configuration, the future user position information may be treated as the receiving position information by being combined with the receiving time information to be generated by the receiving time prediction unit 215 described later.

Furthermore, the action prediction unit 211 generates information indicating a state of the user in the future (future user state information) by predicting the future user state. Note that, in this regard, the state of the user may include, for example, whether or not the user is moving, action labels (exercise, train, etc.), whether the user is indoors or outdoors, a store or station at which to stay, whether or not the user has luggage, whether or not the user has an object such as a handbag that is possible to contain the delivery object, whether or not there is an accompanying person, a state of the accompanying person (whether or not the accompanying person has luggage), and the like.

In this regard, it is considered that the information as to whether or not there is an accompanying person, whether or not the user has luggage, and whether or not the user has a handbag, are important information particularly for determining the receiving method. Therefore, in the following, an example of a method in which the action prediction unit 211 predicts such pieces of information will be described. Note that the action prediction unit 211 may predict a current state and then predict a future state on the basis of the current state, and the prediction method described below includes a current state prediction method.

The action prediction unit 211 may predict whether or not there is the accompanying person on the basis of, for example, the user information acquired from the user terminal 1 and information of the accompanying person acquired from an external device or system. For example, in a case where it is possible to acquire schedule information included in the user information and schedule information of another person, it is possible to predict whether or not there is a current or future accompanying person on the basis of these pieces of schedule information. Furthermore, in a case where position information to be acquired by performing sensing is close to position information of a person who is a social media friend, it is determined that the person is accompanying, making it possible to predict whether or not there is a current accompanying person.

For example, in a case where the schedule information of the user is acquired as the user information, the action prediction unit 211 may predict whether or not the user has luggage and whether or not the user has a handbag at present or in the future on the basis of the user's intention included in the schedule information (e.g., commuting, overseas travelling, skiing, leisure, etc.).

Furthermore, the action prediction unit 211 may predict whether or not the user has luggage and whether or not the user has a handbag at present or in the future by using the predictor obtained by machine learning. It is possible to obtain such a predictor, for example, by learning the learning data that includes information about what kind of baggage a prediction target user or other users similar to the prediction target user had in the past, and under what kind of conditions the user had such kind of baggage.

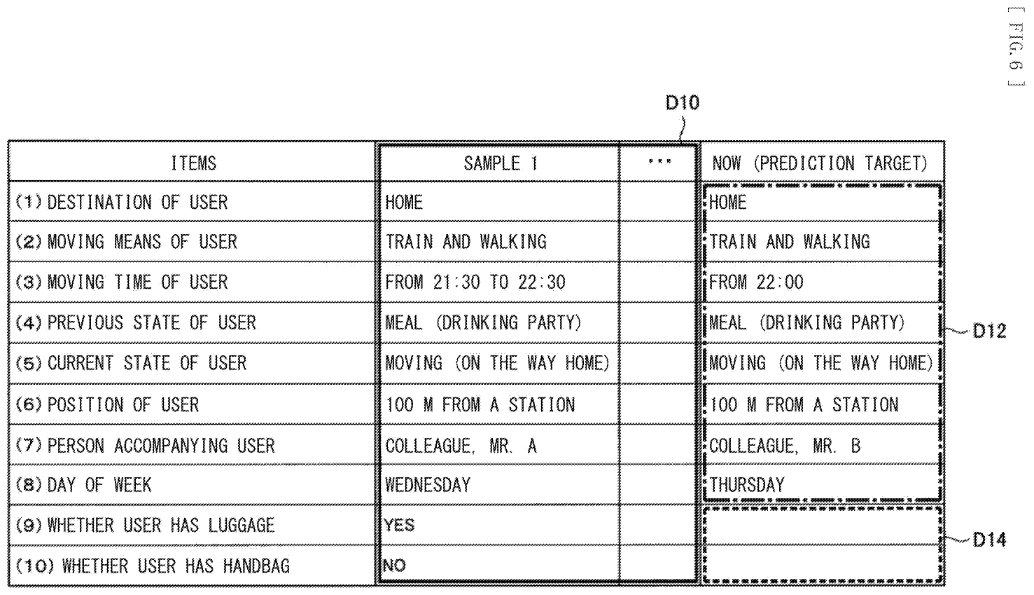

In this regard, with reference to FIG. 6, an example of a method of predicting whether or not a user currently has luggage will be described. FIG. 6 is an explanatory diagram for describing the example of the method of predicting whether or not the user currently has luggage.

As illustrated in FIG. 6, it is possible to obtain the predictor by learning using data D10 including a plurality of samples as learning data, in which a single sample includes an information set of items (1) to (10). Note that, in this regard, the information of each of the items (1), (2), (4), and (5) is information that is to be acquired as the user information from the user terminal 1, or is to be acquired by performing prediction by another method on the basis of the user information or the like. Furthermore, the information of each of the items (3), (6), and (7) is information acquired on the basis of sensing performed by the sensor unit 12.

Then, using data D12 including the information of each of the current items (1) to (8) to be inputted to the predictor makes it possible to predict data D14 of prediction target items (9) and (10).

In addition, it is also possible to predict the status of the accompanying person of the user (for example, whether or not he/she has luggage) in the similar manner as the above-described method of predicting the status of the user.

Description will be continued by returning to FIG. 5. The intended purpose prediction unit 213 generates intended purpose information related to an intended purpose of the delivery object by predicting the intended purpose of the delivery object on the basis of the user information and the delivery object information. The intended purpose information may be information to be used for work, to be used at a place to go (destination), to be used at home, or to be used as a replacement part.

The intended purpose prediction unit 213 may perform prediction related to the intended purpose of the delivery object by machine learning. For example, the prediction related to the intended purpose of the delivery object may be performed by using a predictor obtained by learning previously prepared learning data. In such a case, the learning data may include, for example, a plurality of sample data obtained by combining the above-described delivery object information and the intended purpose of the delivery object (correct answer data).

The receiving time prediction unit 215 generates the receiving time information by performing a prediction related to a time at which the user is able to receive the delivery object. As illustrated in FIG. 5, the receiving time prediction unit 215 performs the prediction related to the time at which the user is able to receive the delivery object on the basis of the future user position information and the future user state information generated by the action prediction unit 211, and the intended purpose information generated by the intended purpose prediction unit 213, in addition to the user information and the delivery object information.

Using the delivery object information for such a prediction makes it possible to generate the receiving time information depending on, for example, the size, the weight, the storage method, etc. of the delivery object. Furthermore, using the future user position information for such a prediction makes it possible to generate the receiving time information after determining, for example, whether or not the delivery person is able to deliver the delivery object to a position where the user exists in the future. Moreover, using the future user state information for such a prediction makes it possible to generate the receiving time information after determining, for example, whether or not the user is able to take the delivery object home. Also, using the intended purpose information for such a prediction makes it possible to generate the receiving time information depending on, for example, when and where the user necessitates the delivery object.

Note that prediction methods using the above-described information by the receiving time prediction unit 215 may be diverse. For example, the receiving time prediction unit 215 may perform the prediction related to the time at which the user is able to receive the delivery object by machine learning as well as the action prediction unit 211 and the intended purpose prediction unit 213 described above. Alternatively, the receiving time prediction unit 215 may perform the prediction related to the time at which the user is able to receive the delivery object on the basis of a predetermined rule. Furthermore, the prediction related to the time at which the user is able to receive the delivery object may be performed by a combination of the above.

The generation unit 21 generates the receiving method information including the receiving position information and the receiving time information, in which the future user position information at the time indicated by the receiving time information generated by the above-described receiving time prediction unit 215 is set as the receiving position information. Note that there may be a plurality of pieces of receiving method information generated by the generation unit 21. For example, the generation unit 21 may generate the plurality of pieces of receiving method information corresponding to the plurality of receiving method candidates. Then, the generation unit 21 provides the plurality of pieces of receiving method information to the adjustment control unit 23.

Note that although a timing at which the generation unit 21 generates the receiving method information is not particularly limited, the generation unit 21 may generate the receiving method information, for example, in a case where the communication unit 29 receives the shipping notification indicating that the delivery object has been delivered from the delivery company system 3. Furthermore, the generation unit 21 may generate (regenerate) the receiving method information in a case where it is determined that it is difficult to perform the reception by the currently arranged receiving method (e.g., a receiving method selected by the user in the past) on the basis of the user information. For example, a case where it is difficult to perform the reception may be a case where the user is unable to reach a position indicated by the receiving position information included in the receiving method information, by a time indicated by the receiving time information included in the receiving method information. Note that the timing at which the generation unit 21 generates the receiving method may be controlled by the adjustment control unit 23 described later.

The adjustment control unit 23 performs processing for adjusting the receiving method between the user (more accurately, the user terminal 1) and the delivery company system 3. For example, the adjustment control unit 23 controls the communication unit 29 to inquire of the user terminal 1 and the delivery company system 3 for information necessary for generating and adjusting the receiving method.

Furthermore, the adjustment control unit 23 may control the timing at which the generation unit 21 generates the receiving method. For example, the adjustment control unit 23 may instruct the generation unit 21 to generate the receiving method information in a case where the shipping notification is received as described above. Furthermore, the adjustment control unit 23 may determine whether or not it is difficult to perform the reception by the current receiving method (e.g., the receiving method selected by the user) on the basis of the user information received from the user terminal 1 via the communication unit 29. For example, in a case where the user exists at a position different from the planned route, it may be difficult to perform the reception by the currently arranged receiving method. As described above, in the case where it is determined that it is difficult to perform the reception by the current receiving method, the adjustment control unit 23 may instruct the generation unit 21 to generate the receiving method information.

Furthermore, the adjustment control unit 23 controls the communication unit 29 or provides the output control unit 25 with information such as the receiving method information, thereby causing the communication unit 29 to transmit information for adjustment to the user terminal 1 and the delivery company system 3. For example, in a case where the adjustment control unit 23 receives the user selection information from the user terminal 1, the adjustment control unit 23 may control the communication unit 29 to transmit the receiving method information corresponding to the receiving method selected by the user to the delivery company system 3. Note that other processing for the adjustment of the receiving method by the control of the adjustment control unit 23 will be described later.

Furthermore, the output control unit 25 performs output control for causing various kinds of information to be presented to the user. For example, the output control unit 25 may perform such output control by generating the output control information for the user terminal 1 to perform output (e.g., display or sound output) and causing the communication unit 29 to transmit the generated output control information to the user terminal 1. The information that is caused to be presented to the user by the output control unit 25 may be various, and some examples thereof will be described below.

For example, the output control unit 25 may generate the output control information for causing the receiving method information generated by the generation unit 21 and provided from the adjustment control unit 23 to be presented to the user, and causes the communication unit 29 to transmit the output control information to the user terminal 1, thereby causing the receiving method information to be presented to the user. Furthermore, in a case where the plurality of pieces of receiving method information corresponding to the plurality of receiving method candidates is generated by the generation unit 21, the output control unit 25 may cause the plurality of pieces of receiving method information to be presented to the user. This configuration allows the user to select a desired receiving method from the plurality of receiving method candidates.

Furthermore, the output control unit 25 may cause an alert for guiding the user to be presented to the user on the basis of the receiving method information corresponding to the currently arranged receiving method. For example, the output control unit 25 may cause the alert that appropriately guides the user to be presented while monitoring whether or not the user appropriately approaches the receiving position on the basis of the user information received by the communication unit 29 from the user terminal 1. Note that such an alert may be presented by a display, a sound output (voice guidance), or a vibration output of the user terminal 1. Furthermore, the output control unit 25 may present such an alert to the user by generating output control information for presenting such an alert and transmitting the output control information to the user terminal 1. Hereinafter, some examples of the alert will be described.

For example, the output control unit 25 may cause the alert notifying that the delivery object will be received to be presented to the user on a day of delivery. In such a case, for example, the output control unit 25 may cause the user with the alert notifying that the delivery object will arrive at the user's home at night to be presented to the user before the user goes to an office on a morning of the delivery. Such an alert may include the delivery object information (e.g., information of a type of the delivery object), the receiving method information, and the like. This configuration allows the user to recognize luggage to be received on that day.

Furthermore, the output control unit 25 may also cause the alert notifying that the user has approached the receiving position to be presented to the user in a case where it is determined on the basis of the user information that the user has approached the receiving position indicated by the currently arranged receiving method information. For example, the output control unit 25 may cause the alert to be presented, in a case where the user has approached a convenience store which is the receiving position of the delivery object, or in a case where the user has approached a station where he/she should stop off to receive the delivery object. This configuration allows the user to more easily recognize the receiving position.

Furthermore, the output control unit 25 may also cause the alert for guiding the user to the receiving position to be presented in a case where it is determined that it is difficult for the user to reach the receiving position by him/herself, for instance, a case where the user has passed the receiving position. For example, in a case where it is determined on the basis of the user information that the user exists at a position different from the receiving position (e.g., a case where it is recognized that the user entered a different street or building), the alert notifying that the user exists at the position different from the receiving position may be presented. This configuration allows the user to recognize that the user him/herself is in a wrong position.

Furthermore, the output control unit 25 may cause the alert to be presented in a case where an arrival time at the receiving position of the user is predicted on the basis of the user information, and it is determined that the predicted arrival time is later than the receiving time. This configuration allows the user to recognize in advance that he/she is unable to reach the receiving position at the receiving time of luggage. Furthermore, the output control unit 25 may also cause the alert including route information to the receiving position to be presented. This configuration allows the user to recognize a route to the receiving position and more easily go to the receiving position.

The storage unit 27 stores programs and data used for operation of the server 2. For example, the storage unit 27 may store the user information and the like that the communication unit 29 has received from the user terminal 1 so far (in the past).

The communication unit 29 is a communication module for transmitting and receiving data to/from other devices (e.g., the user terminal 1 and the delivery company system 3) by wired or wireless communication. The communication unit 29 wirelessly communicates with an external device directly or via a network access point by a communication scheme such as wired LAN, wireless LAN, Wi-Fi, infrared communication, Bluetooth (registered trademark), or near-field/non-contact communication.

For example, the communication unit 29 receives the user information and the user selection information from the user terminal 1, and receives the delivery object information, information related to delivery schedule, arrangement information, and the like from the delivery company system 3. As described above, the communication unit 29 transmits, to the delivery company system 3, the receiving method information corresponding to the receiving method selected by the user among the plurality of pieces of receiving method information. Furthermore, the communication unit 29 transmits, to the user terminal 1, the output control information that is generated by the output control unit 25 for causing various kinds of information to be presented.

### 3. Operation

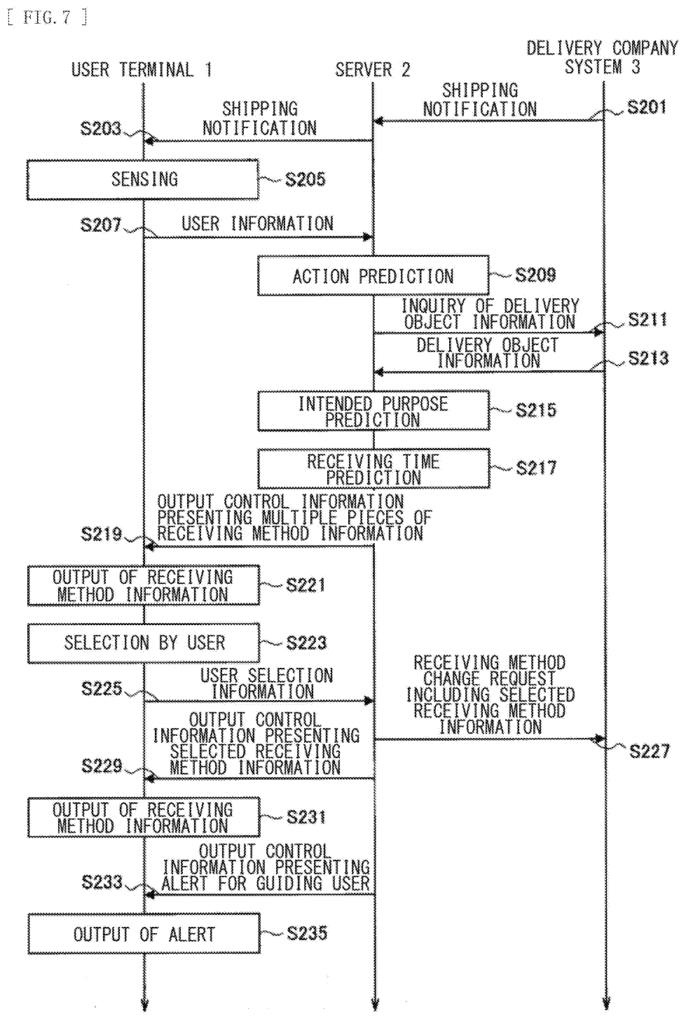

In the above, the configurations of the user terminal 1 and the server 2 according to the present embodiment have been described. Subsequently, an operation example of the information processing system according to the present embodiment will be described. FIG. 7 is a sequence diagram that illustrates an example of an operation of the information processing system according to the present embodiment.

First, the shipping notification indicating that the delivery object has been shipped is transmitted from the delivery company system 3 to the server 2 (S201). Subsequently, the shipping notification is transmitted from the server 2 to the user terminal 1 (S203). The sensor unit 12 of the user terminal 1 performs sensing to acquire the user information such as the user position information in response to reception of the shipping notification in step S203 (S205).

Subsequently, the user information is transmitted from the user terminal 1 to the server 2 (S207). The user information transmitted in step S207 may include the user information acquired by performing sensing in step S205. Note that although FIG. 7 illustrates an example in which the user information is transmitted only once, the user terminal 1 may use the shipping notification as a trigger and constantly or periodically perform the sensing thereafter, and may constantly or periodically transmit the user information to the server 2. Furthermore, the user terminal 1 may constantly or periodically perform the sensing or may constantly or periodically transmit the user information to the server 2 without depending on the shipping notification.

The action prediction unit 211 of the server 2 that has received the user information generates the future user position information and the future user state information by performing action prediction processing that predicts the future user position and the future user state on the basis of the received user information (S209). Furthermore, the adjustment control unit 23 of the server 2 inquires of the delivery company system 3 about the delivery object information (S211), and in response to the inquiry, the delivery object information is transmitted from the delivery company system 3 to the server 2 (S213). Note that such delivery object information may be transmitted to the server 2 together with the shipping notification in step 201.

Subsequently, the intended purpose prediction unit 213 of the server 2 generates the intended purpose information by predicting the intended purpose of the delivery object on the basis of the user information received in step S207 and the delivery object information received in step S213 (S215). Then, the receiving time prediction unit 215 of the server 2 generates the receiving time information by performing the prediction related to the time at which the user is able to receive the delivery object (S217). In step S217, information used for the prediction by the receiving time prediction unit 215 may include the user information, the delivery object information, the future user position information, the future user state information, and the intended purpose information, as described above.

According to the processing of steps S209 to S217, the generation unit 21 (the action prediction unit 211, the intended purpose prediction unit 213, and the receiving time prediction unit 215) makes it possible to generate the plurality of pieces of receiving method information (the receiving position information and the receiving time information) corresponding to the plurality of receiving method candidates. Then, the output control information for presenting the generated plurality of pieces of receiving method information is generated by the output control unit 25 and transmitted from the server 2 to the user terminal 1 (S219).

The user terminal 1 performs an output (e.g., display) of presenting the plurality of pieces of receiving method information to the user according to the output control information received in step S219 (S221). Then, the user who uses the user terminal 1 selects the receiving method from the plurality of receiving method candidates via the input unit 15 for the user terminal 1 (S223). The user selection information related to the user's selection in step S223 is transmitted from the user terminal 1 to the server 2 (S225). Then, the adjustment control unit 23 of the server 2 controls the communication unit 29 to transmit a receiving method change request including the receiving method information corresponding to the receiving method selected by the user (which is also simply referred to as a selected receiving method information) to the delivery company system 3 (S227). Note that although not illustrated in FIG. 7, the delivery company system 3 may transmit to the server 2 arrangement information indicating that delivery arrangement has been completed according to the received receiving method change request.

Furthermore, the output control unit 25 of the server 2 generates the output control information for presenting the selected (arranged) receiving method information, and controls the communication unit 29 to transmit the output control information to the user terminal 1 (S229). Then, the user terminal 1 performs an output (e.g., display) of presenting the selected receiving method information to the user according to the output control information received in step S229 (S231).

Furthermore, the output control unit 25 of the server 2 generates the output control information for presenting the alert for guiding the user and controls the communication unit 29 to transmit the output control information to the user terminal 1 (S233). Then, the user terminal 1 performs an output (e.g., a display, a sound output, a vibration output, or the like) of presenting the alert to the user according to the output control information received in step S233 (S235). The user moves to the receiving position according to the guidance of the alert to receive the delivery object from the delivery person. Note that a timing of presenting the alert may be various as described above.

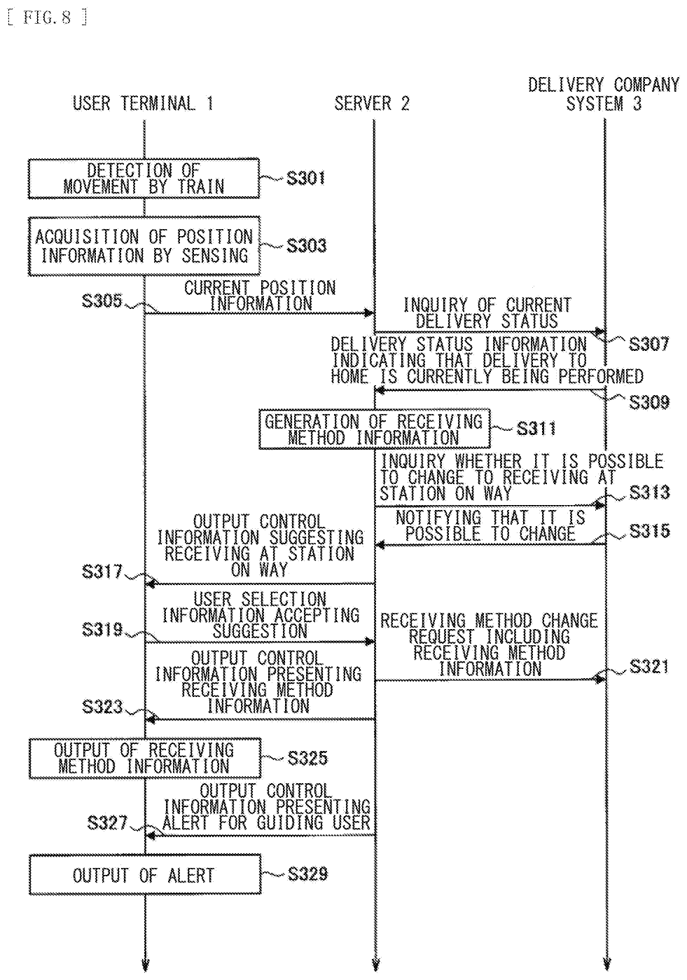

In the above, one example of operations of the information processing system according to the present embodiment has been described. Operations of the information processing system according to the present embodiment are of course not limited to the example illustrated in FIG. 7. For example, in the example illustrated in FIG. 7, the example in which a series of processing is started by using a matter that the shipping notification is sent from the delivery company system 3 as a trigger has been described. However, the server 2 according to the present embodiment may start the series of processing by using the transmission of the user information from the user terminal 1 as the trigger. Such an example will be described with reference to FIG. 8. FIG. 8 is a sequence diagram that illustrates another operation example of the information processing system according to the present embodiment.

In the example illustrated in FIG. 8, the user terminal 1 first detects movement by train (S301). Note that there are various methods of detecting movement by train, and such detection may be performed by, for example, the control unit 11 on the basis of the sensor data acquired by the sensor unit 12.

Subsequently, the current user position information (an example of the user information) is acquired by sensing performed by the sensor unit 12 of the user terminal 1 (S303), and transmitted from the user terminal 1 to the server 2 (S305). Subsequently, the adjustment control unit 23 of the server 2 controls the communication unit 29 to inquire of the delivery company system 3 about the current delivery status (S307). In the example illustrated in FIG. 8, the delivery company system 3 transmits to the server 2 the delivery status information indicating that delivery is currently being performed to the home in response to the inquiry in step S307 (S309). Then, the generation unit 21 of the server 2 generates the receiving method information (S311). Note that the generation processing of the receiving method information in step S311 may be similar to those of steps S209 to S217 described with reference to FIG. 7, and thus detailed description thereof is omitted here.

In this regard, an example will be described in which receiving method information corresponding to a receiving method for receiving at a station along a route of a train on which the user rides is generated in step S311. In such a case, the adjustment control unit 23 of the server 2 inquires of the delivery company system 3 whether it is possible to change to the receiving at the station on the way (S313). In this regard, if the delivery company system 3 notifies that it is possible to change (S315), the output control unit 25 of the server 2 controls the communication unit 29 to transmit, to the user terminal 1, the output control information for suggesting the receiving at the station along the route (S317).

Then, if the suggestion is accepted through the interaction between the user terminal 1 and the user, the user selection information of accepting the suggestion is transmitted from the user terminal 1 to the server 2 (S319). Subsequently, the server 2 transmits the receiving method change request including the accepted receiving method information to the delivery company system 3 (S321). Note that although not illustrated in FIG. 8, the delivery company system 3 may transmit, to the server 2, the arrangement information indicating that delivery arrangement has been completed according to the received receiving method change request.

Furthermore, the output control unit 25 of the server 2 generates the output control information for presenting the accepted (arranged) receiving method information, and controls the communication unit 29 to transmit the output control information to the user terminal 1 (S323). Then, the user terminal 1 performs an output (e.g., display) of presenting the receiving method information to the user according to the output control information received in step S323 (S325).

Furthermore, the output control unit 25 of the server 2 generates the output control information for presenting the alert for guiding the user, and controls the communication unit 29 to transmit the output control information to the user terminal 1 (S327). Then, the user terminal 1 performs an output (e.g., a display, a sound output, a vibration output, or the like) to present the alert to the user according to the output control information received in step S327 (S329). The user gets off a train at a stopover station according to the guidance of the alert to receive the delivery object from the delivery person.

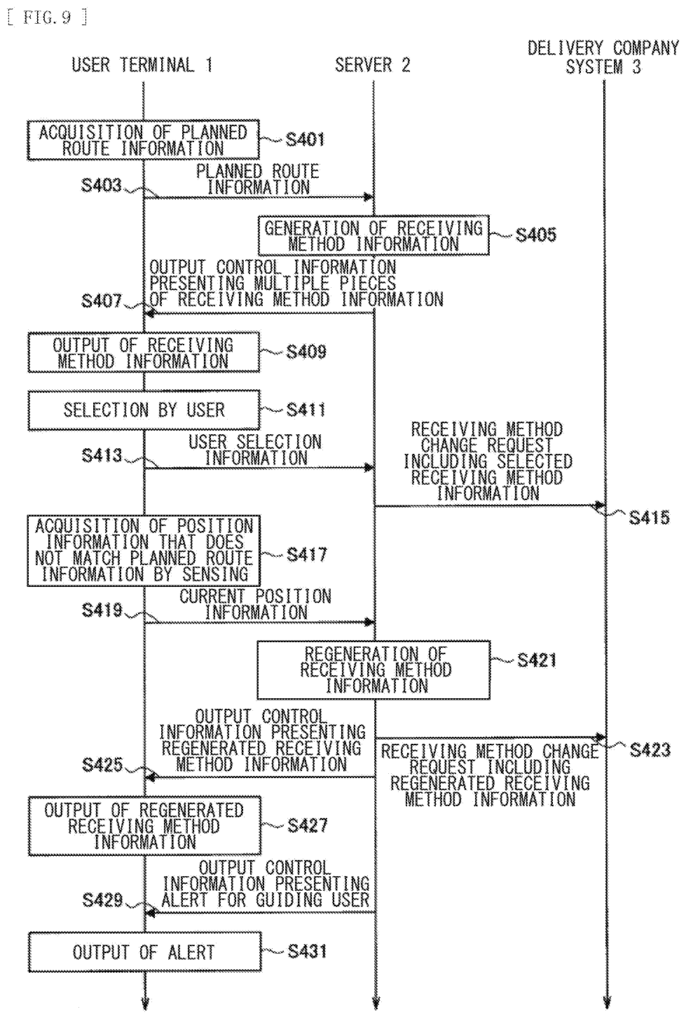

In the above, the operation example in which the series of processing is started by using the transmission of the user information from the user terminal 1 as the trigger has been described. Subsequently, a description will be given below with reference to FIG. 9 to an operation example of the information processing system according to the present embodiment in a case where difficulties arise in receiving by once-selected receiving method. FIG. 9 is a sequence diagram that illustrates another operation example of the information processing system according to the present embodiment.

In the example illustrated in FIG. 9, the user terminal 1 first acquires the planned route information (an example of the user information) by an input of the user via the input unit 15 or from the storage unit 16 (S401) and transmits the planned route information to the server 2 (S403). Subsequently, the generation unit 21 of the server 2 generates the receiving method information on the basis of the planned route information received in step S403 (S405).

Note that the generation processing of the receiving method information in step S405 may be similar to those of steps S209 to S217 described with reference to FIG. 7, and thus detailed description thereof is omitted here. In addition, the processes of steps S409 to S415 illustrated in FIG. 9 may be similar to those of steps S219 to S227 described with reference to FIG. 7, and thus detailed description thereof is omitted here.

In this regard, in the example illustrated in FIG. 9, in step S417, the sensor unit 12 of the user terminal 1 acquires the user position information that does not match the planned route information by performing sensing (S417), and the acquired current user position information is transmitted from the user terminal 1 to the server 2 (S419). Note that whether or not the position information acquired by performing sensing matches the planned route information may be determined by the control unit 11 of the user terminal 1 or may be determined by the server 2.

The adjustment control unit 23 of the server 2, which has received the position information that does not match the planned route information, determines that it is difficult to perform reception by means of the currently arranged receiving method (the receiving method selected in step S411), and the generation unit 21 regenerates the receiving method information (S421). Then, the receiving method change request including the receiving method information regenerated in step S421 is transmitted from the server 2 to the delivery company system 3. Note that although not illustrated in FIG. 9, the delivery company system 3 may transmit, to the server 2, the arrangement information indicating that the delivery arrangement has been completed according to the receiving method change request that has been received.

Furthermore, the output control unit 25 of the server 2 generates the output control information for presenting the receiving method information regenerated in step S421, and controls the communication unit 29 to transmit the output control information to the user terminal 1 (S425). Then, the user terminal 1 performs an output (e.g., display) of presenting the selected receiving method information to the user according to the output control information received in step S425 (S427).

Furthermore, the output control unit 25 of the server 2 generates the output control information for presenting the alert for guiding the user, and controls the communication unit 29 to transmit the output control information to the user terminal 1 (S429). Then, the user terminal 1 performs an output (e.g., a display, a sound output, a vibration output, or the like) to present the alert to the user according to the output control information received in step S429 (S431). The user moves to the receiving position according to the guidance of the alert and receives the delivery object from the delivery person.

### 4. Specific Example of User Interface

In the above, some operation examples of the information processing system according to the present embodiment have been described. Subsequently, some examples of the user interface (screen) that presents the receiving method information according to the present embodiment will be specifically described with reference to FIGS. 10 to 13. Note that the user interface described below is displayed on the display unit 13 of the user terminal 1 according to the output control information generated by the output control unit of the server 2 and transmitted to the user terminal 1 as described above.

FIG. 10 is a diagram that illustrates an example of a user interface in which pieces of receiving method information respectively corresponding to a plurality of receiving method candidates are presented. In the example illustrated in FIG. 10, for example, it is learned in advance that a workplace of the user exists at a place that is reachable from a B station on foot and the user passes through the B station in morning and evening or at night.

Furthermore, the server 2 predicts that an arrival home time of the user of a next day when the delivery object is scheduled to be delivered will be later than a deliverable time of the delivery object to the user's home. As a result, a screen G10 illustrated in FIG. 10 displays a text G11 that suggests changing the receiving method. Furthermore, the screen G10 displays a predicted return home route G13 for tomorrow. Furthermore, the screen G10 displays first receiving method information G15 corresponding to a first receiving method candidate and second receiving method information G17 corresponding to a second receiving method candidate on the basis of two pieces of receiving method information generated by the server 2.

It is possible for the user to select a desired receiving method by selecting, for example, either the first receiving method information G15 or the second receiving method information G17 displayed on the screen G10.

Note that, before the screen G10 is displayed on the user terminal 1, the server 2 may confirm with the delivery company system 3 whether or not it is possible to change each receiving method, and display only the receiving method information related to changeable receiving methods.

FIG. 11 is a diagram that illustrates an example of a user interface for displaying the receiving position on a map. A screen G20 illustrated in FIG. 11 indicates a map G21 of an area where the user is currently staying.

In the example illustrated in FIG. 11, it is assumed that the server 2 predicts that the user will stay in the area where the user is currently staying for several more hours by action prediction of the user. Then, the server 2 makes a list of places that exist near the user and where the delivery object is storable and receivable on the basis of the current user position information. In addition, the server 2 predicts a moving route of the user on the basis of, for example, a prediction of a train on which the user will take to return.

Then, the server 2 confirms with the delivery company system 3 whether or not it is possible to change the receiving method to a receiving method of receiving at a convenience store, because the list of places includes the convenience store that exist in on the way of the moving route. As a result of the above processing, the server 2 causes the screen G20 to display a text G23 that suggests the receiving method of receiving at the convenience store.

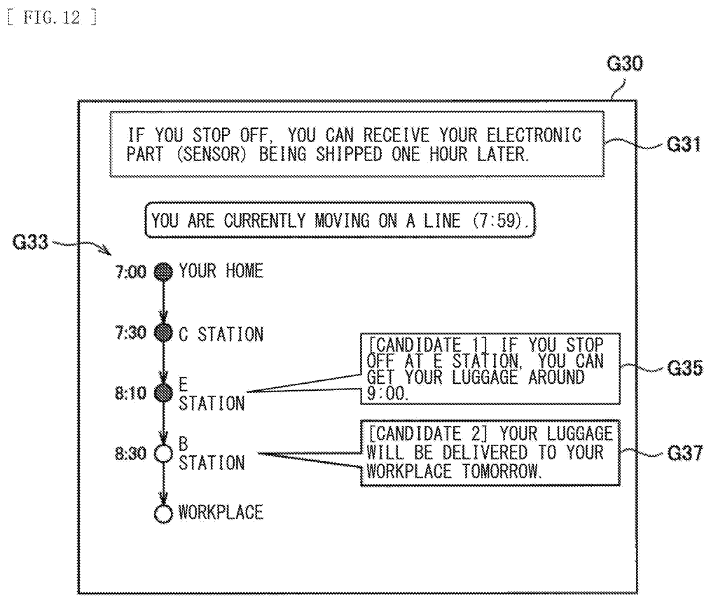

FIG. 12 is a diagram that illustrates an example of a user interface that suggests a change to a receiving method of receiving the delivery object that the user wishes to quickly receive. In the example illustrated in FIG. 12, it is assumed that the user is in a movement state but wishes to quickly receive an electronic part (sensor) that is the delivery object currently being delivered.

In this regard, for example, if the delivery object information indicating that the user wishes to quickly receive the delivery object is acquired, the server 2 acquires the delivery schedule information from the delivery company system 3 in response to the delivery object information. In a case where it is determined that a current delivery schedule is inconvenient because the user will be late in receiving the delivery object according to the current delivery schedule, the server 2 generates, for example, the receiving method information of getting off a train at a stopover station to receive the delivery object, as a receiving method that makes it possible to receive the delivery object earlier than the case of the current delivery schedule. Then, the server 2 causes a screen G30 to display a text G31 for suggesting that it is possible to receive the delivery object earlier by getting off a train at a stopover station. This allows the user who sees the display to know that it is possible to quickly receive luggage if he/she changes an action (i.e., it is possible to receive the delivery object earlier than the case according to the current delivery schedule).

As illustrated in FIG. 12, the screen G30 displays a predicted current moving route G33. Furthermore, on the basis of generated two pieces of the receiving method information, the screen G30 displays first receiving method information G35 corresponding to the receiving method of receiving the delivery object by getting off a train at a stopover station that is a first receiving method candidate and a second receiving method information G37 corresponding to second receiving method candidate (for example, originally scheduled receiving method). This allows the user who sees the receiving method (an action after the change) to know how to change an action in order to quickly receive luggage (i.e., in order to receive the delivery object earlier than the case according to the current delivery schedule).

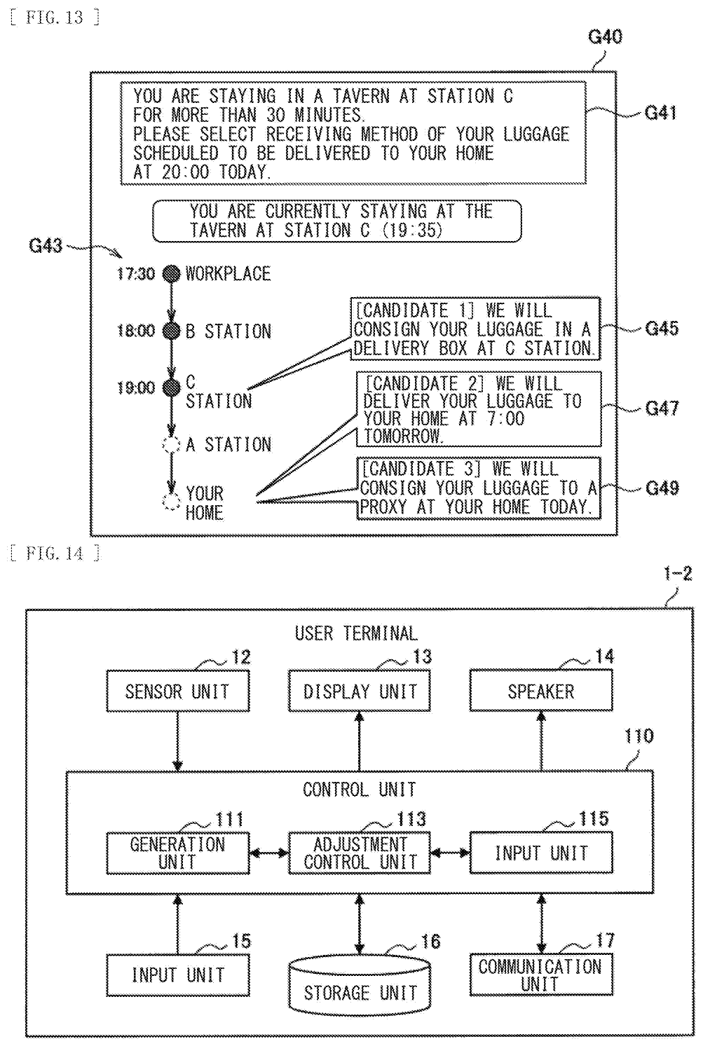

FIG. 13 is a diagram that illustrates an example of a user interface for re-adjusting the receiving method in a case where an action of the user is different from a schedule. In the example illustrated in FIG. 13, for example, it is assumed that the user was supposed to return home from a workplace and receive the delivery object at home, but the user goes to a tavern, and thus the server 2 determines that it is difficult for the user to return home at 20:00, which is a scheduled delivery time. Then, the server 2 generates pieces of receiving method information respectively corresponding to a plurality of receiving method candidates that make it possible to receive the delivery object even in such a case, and causes the display unit 13 of the user terminal 1 to display the pieces of receiving method information.

A screen G40 illustrated in FIG. 13 displays a text G41 for suggesting changing the receiving method of the delivery object because the user's action is different from the schedule. Furthermore, the screen G40 displays a predicted moving route G43. Furthermore, on the basis of three pieces of receiving method information generated by the server 2, the screen G40 displays first receiving method information G45 corresponding to a first receiving method candidate, second receiving method information G47 corresponding to a second receiving method candidate, and third receiving method information G49 corresponding to a third receiving method candidate.

In the above, some examples of the user interface for presenting the receiving method information have been described. Note that the user interface for presenting the receiving method information is not limited to the above-described examples. Furthermore, although the example in which the receiving method information is displayed on the display unit 13 of the user terminal 1 has been described in the above, the receiving method information may be outputted by voice from the speaker 14.

### 5. Modification Examples

In the above, an embodiment of the present disclosure has been described. In the below, some modification examples of an embodiment of the present disclosure will be described. Note that each modification example described below may be applied to an embodiment of the present disclosure alone or in combination. Furthermore, each modification example may be applied instead of the configuration described in the embodiment of the present disclosure, or may be additionally applied to the configuration described in the embodiment of the present disclosure.

<5-1. First Modification Example>

In the above-described embodiment, an example in which a function as the receiving agent is achieved by the server 2 described with reference to FIGS. 4 and 5 has been described, but the function may be achieved by another device. As a first modification example, an example in which the user terminal has the function as the receiving agent will be described.

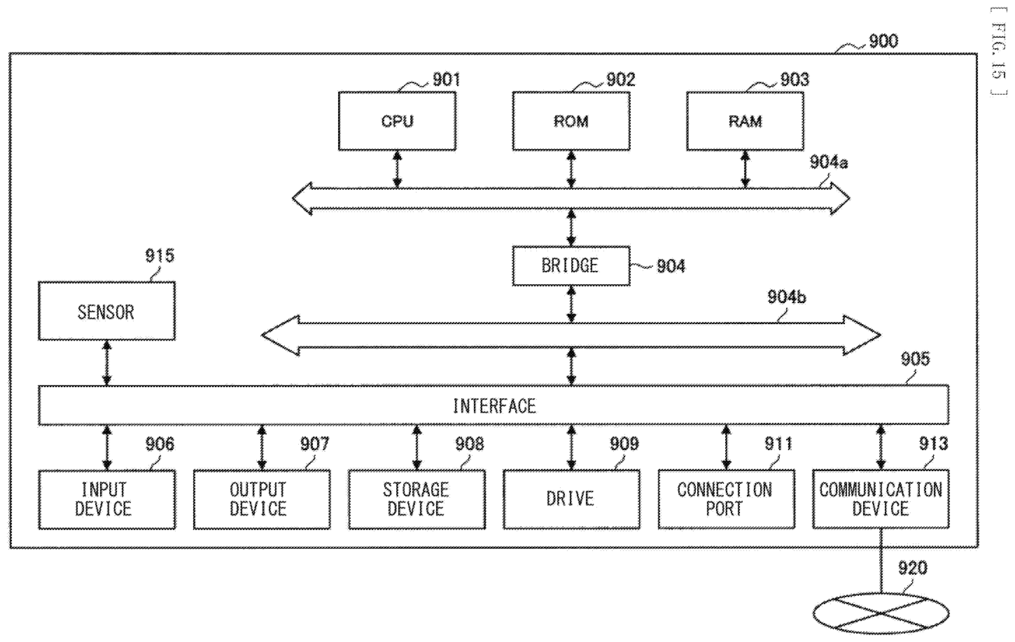

FIG. 14 is a block diagram that illustrates a configuration example of a user terminal 1-2 according to the present modification example. In this modification example, the user terminal 1-2 has the function as the receiving agent, the user terminal 1-2 may be coupled to the delivery company system 3 without going through the above-mentioned server.

Functions of the sensor unit 12, the display unit 13, the speaker 14, the input unit 15, the storage unit 16, and the communication unit 17 illustrated in FIG. 14 may be the same as the functions of the sensor unit 12, the display unit 13, the speaker 14, the input unit 15, the storage unit 16, and the communication unit 17 described with reference to FIG. 2, and thus detailed description thereof is omitted here. The user terminal 1-2 illustrated in FIG. 14 is different from the user terminal 1 illustrated in FIG. 2 in a point that the user terminal 1-2 has a control unit 110 having functions as a generation unit 111, an adjustment control unit 113, and an output control unit 115.

In a similar manner as the generation unit 21 described with reference to FIGS. 4 and 5, the generation unit 111 generates the receiving method information on the basis of the user information and the delivery object information. In this regard, the generation unit 111 is different from the above-described generation unit 21 in a point of an internal configuration of the user terminal 1-2, that is, for example, a point in that the user information is provided from the sensor unit 12, the input unit 15, the storage unit 16, or the like. However, other points may be similar to those of the above-described generation unit 21.

In a similar manner as the adjustment control unit 23 described with reference to FIG. 4, the adjustment control unit 113 performs processing related to adjustment of the receiving method between the user and the delivery company system 3.

Furthermore, the output control unit 115 performs output control for presenting various kinds of information to the user, in a similar manner as the output control unit 25 described with reference to FIG. 4. The output control unit 115 is different from the above-described output control unit 25 in a point that the output control unit 115 makes it possible to perform output control by directly controlling the display unit 13 and the speaker 14 without using communication. However, other points may be similar to those of the above-described output control unit 25.

<5-2. Second Modification Example>

In the first modification example described above, an example in which all the functions related to the receiving agent are achieved by the user terminal 1 has been described, but the functions related to the receiving agent may be distributed to and provided by a plurality of devices. In the following, some examples in which the user terminal 1 is provided with some functions related to the receiving agent, and the server 2 is provided with the remaining functions related to the receiving agent will be described.

For example, the user terminal 1 may have a function as the generation unit, and the server 2 may have a function as the adjustment control unit and a function as the output control unit. In such a case, receiving method information generated by the user terminal 1 may be provided to the server 2, and the server 2 may perform processing related to adjustment of the receiving method on the basis of the receiving method information generated by the user terminal 1 and processing related to output control for presenting various information.

Furthermore, the server 2 may have the function as the generation unit and the function as the adjustment control unit, and the user terminal 1 may have the function as the output control unit. In such a case, the receiving method information generated by the server 2 may be provided to the user terminal 1, and the user terminal 1 may perform processing related to the output control for presenting various kinds of information on the basis of the receiving method information.

Furthermore, the user terminal 1 may have a function of the action prediction unit, and the predicted future user position information and future user state information may be provided to the server 2, and may generate receiving information on the basis of those pieces of information of the server 2. In such a case, the configuration of the server 2 for generating the receiving information may be understood as the generation unit. The future user position information and the future user state information may be understood as the user information.

### 6. Hardware Configuration Example

In the above, embodiments of the present disclosure have been described. Finally, a hardware configuration of the information processing apparatus according to the embodiment of the present disclosure will be described with reference to FIG. 15. FIG. 15 is a block diagram that illustrates an example of a hardware configuration of the information processing apparatus according to an embodiment of the present disclosure. An information processing apparatus 900 illustrated in FIG. 15 may serve as the user terminal 1, the user terminal 1-2, and the server 2 described above. Information processing performed by the user terminal 1, the user terminal 1-2, and the server 2 according to an embodiment of the present disclosure is achieved by cooperation of software and hardware that is described below.

As illustrated in FIG. 15, the information processing apparatus 900 includes a CPU (Central Processing Unit) 901, a ROM (Read Only Memory) 902, a RAM (Random Access Memory) 903, and a host bus 904a. Furthermore, the information processing apparatus 900 includes a bridge 904, an external bus 904b, an interface 905, an input device 906, an output device 907, a storage device 908, a drive 909, a connection port 911, a communication device 913, and a sensor 915. The information processing apparatus 900 may have a processing circuit such as a DSP or an ASIC instead of or in addition to the CPU 901.

The CPU 901 functions as an arithmetic processing device and a control device, and controls overall operations in the information processing apparatus 900 according to various programs. Furthermore, the CPU 901 may be a microprocessor. The ROM 902 stores programs, calculation parameters, etc. used by the CPU 901. The RAM 903 temporarily stores programs used in execution of the CPU 901 and parameters, etc. that appropriately change during the execution. The CPU 901 may serve as, for example, the control unit 11, the generation unit 21, the adjustment control unit 23, the output control unit 25, and the control unit 110.

The CPU 901, the ROM 902, and the RAM 903 are coupled to each other by the host bus 904a including a CPU bus and the like. The host bus 904a is coupled to the external bus 904b such as a PCI (Peripheral Component Interconnect/Interface) bus via the bridge 904. Note that the host bus 904a, the bridge 904, and the external bus 904b do not necessarily have to be separately configured, and the functions thereof may be mounted on a single bus.

The input device 906 is achieved by a device by which the user inputs information, such as a mouse, a keyboard, a touch panel, a button, a microphone, a switch, and a lever. Furthermore, the input device 906 may be, for example, a remote control device that uses infrared rays or other radio waves, or may be an externally coupled device such as a mobile phone or a PDA that supports operations of the information processing apparatus 900. In addition, the input device 906 may include, for example, an input control circuit that generates an input signal on the basis of information inputted by the user by using the above-described input means and outputs the input signal to the CPU 901. By operating the input device 906, the user of the information processing apparatus 900 is able to input various data and instruct a processing operation to the information processing apparatus 900.

The output device 907 includes a device that makes it possible to visually or auditorily notify the user of acquired information. Examples of such a device include: a display device such as a CRT display device, a liquid crystal display device, a plasma display device, an EL display device, a lamp, or the like; an audio output device such as a speaker or a headphone; a printer device; and the like. The output device 907 outputs, for example, results obtained by various processing performed by the information processing apparatus 900. Specifically, the display device visually displays the results obtained by various processing performed by the information processing apparatus 900 in various formats such as a text, an image, a table, a graph, etc. On the other hand, the audio output device converts an audio signal including reproduced audio data, acoustic data, and the like into an analog signal and audibly outputs the analog signal. The output device 907 may serve as, for example, the display unit 13 and the speaker 14.

The storage device 908 is a data storage device serving as an example of the storage unit of the information processing apparatus 900. The storage device 908 is achieved by, for example, a magnetic storage device such as an HDD, a semiconductor storage device, an optical storage device, a magneto-optical storage device, or the like. The storage device 908 may include a storage medium, a recording device that records data in the storage medium, a reading device that reads data from the storage medium, a deletion device that deletes data recorded in the storage medium, and the like. The storage device 908 stores programs and various data that are executed by the CPU 901, various data acquired from an external source, and the like. The above-described storage device 908 may serve as, for example, the storage unit 16 and the storage unit 27.

The drive 909 is a reader/writer for the storage medium, and is built in or externally attached to the information processing apparatus 900. The drive 909 reads out information recorded in a removable storage medium such as a mounted magnetic disk, optical disk, magneto-optical disk, or semiconductor memory, and outputs the recorded information to the RAM 903. Furthermore, the drive 909 also makes it possible to write information to the removable storage medium.

The connection port 911 is an interface coupled to an external device, and is a connection port with an external device that allows data transmission by, for example, a USB (Universal Serial Bus).

The communication device 913 is a communication interface including, for example, a communication device or the like to be coupled to the network 920. The communication device 913 is, for example, wired or wireless LAN (Local Area Network), LTE (Long Term Evolution), Bluetooth (registered trademark), a communication card for WUSB (Wireless USB), or the like. Furthermore, the communication device 913 may be a router for optical communication, a router for ADSL (Asymmetric Digital Subscriber Line), a modem for various kinds of communication, or the like. The communication device 913 makes it possible to transmit and receive signals and the like to and from, for example, the Internet and another communication device according to a predetermined protocol such as TCP/IP. The communication device 913 may serve as, for example, the communication unit 17 and the communication unit 29.

The sensor 915 includes various sensors such as an acceleration sensor, a gyro sensor, a geomagnetic sensor, an optical sensor, a sound sensor, a distance sensor, a force sensor. The sensor 915 acquires information related to a state of the information processing apparatus 900 itself, such as an attitude and moving speed of the information processing apparatus 900, and information related to a surrounding environment of the information processing apparatus 900, such as brightness and noise around the information processing apparatus 900. Furthermore, the sensor 915 may also include a GPS sensor that receives GPS signals to measure a latitude, a longitude, and an altitude of the apparatus. The sensor 915 may serve as, for example, the sensor unit 12.

Note that the network 920 is a wired or wireless transmission path of information transmitted from a device coupled to the network 920. For example, the network 920 may include a public line network such as the Internet, a telephone line network, and a satellite communication network, various LANs (Local Area Network) and WAN (Wide Area Network) including Ethernet (registered trademark), and the like. Furthermore, the network 920 may also include a dedicated line network such as an IP-VPN (Internet Protocol-Virtual Private Network).

In the above, an example of the hardware configuration that makes it possible to achieve the functions of the information processing apparatus 900 according to the embodiment of the present disclosure has been described. Each constituent element described above may be achieved by using a general-purpose member, or may be achieved by hardware specialized for the function of each constituent element. Therefore, it is possible to appropriately change the hardware configuration to be used according to a technical level at a time of implementing an embodiment of the present disclosure.

Note that it is possible to create a computer program for achieving each function of the information processing apparatus 900 according to the embodiment of the present disclosure as described above, and install the computer program in a PC or the like. Furthermore, it is also possible to provide a computer-readable recording medium in which such a computer program is stored. The recording medium includes, for example, a magnetic disk, an optical disk, a magneto-optical disk, a flash memory, or the like. Furthermore, the above-described computer program may be distributed, for example, via a network, without using the recording medium.

### 7. Summary

As described above, according to the embodiment of the present disclosure, it is possible to further reduce a load relating to delivery.

In the above, preferred embodiments of the present disclosure have been described in detail with reference to the accompanying drawings. However, the technical scope of the present disclosure is not limited to such examples. It is obvious that a person who has ordinary knowledge in the technical field of the present disclosure can conceive of various change examples or various modification examples within a scope of a technical idea recited in the claims, and it is understood that these various examples consequently belong to the technical scope of the present disclosure.

For example, each step in the above-described embodiment does not necessarily have to be processed in time series in order described as a sequence diagram. For example, each step in the processing of the above-described embodiment may be processed in order different from the order described as the sequence diagram, or may be processed in parallel.

Furthermore, the effects described in the present specification are merely explanatory or exemplary effects and are not limited to the above-described effects. Namely, the technology according to the present disclosure may exert other effects that are obvious to those skilled in the art from the description of the present specification, in addition to or instead of the above-described effects.

Note that the following configurations also belong to the technical scope of the present disclosure.

### (1)

An information processing apparatus including a generation unit that generates, on a basis of delivery object information related to a delivery object that is to be delivered to a user and user information related to the user, receiving method information related to a receiving method of the delivery object.

### (2)

The information processing apparatus according to (1), in which the receiving method information includes receiving time information related to a time at which the user is able to receive the delivery object and receiving position information related to a position at which the user is able to receive the delivery object.

### (3)

The information processing apparatus according to (2), in which the generation unit generates the receiving position information by predicting a future position of the user on a basis of the user information.

### (4)

The information processing apparatus according to (2) or (3), in which the generation unit generates the receiving time information by performing prediction related to the time at which the user is able to receive the delivery object on a basis of the user information and the delivery object information.

### (5)

The information processing apparatus according to (4), in which the generation unit performs the prediction related to the time at which the user is able to receive the delivery object on a basis of information including at least one of information indicating a future position of the user or information indicating a future state of the user.

### (6)

The information processing apparatus according to (4) or (5), in which the generation unit performs the prediction related to the time at which the user is able to receive the delivery object on a basis of intended purpose information related to an intended purpose of the delivery object.

### (7)

The information processing apparatus according to any one of (1) to (6), in which the user information includes at least one of information indicating a current or future position of the user or information indicating a future state of the user.

### (8)

The information processing apparatus according to any one of (1) to (7), in which the user information includes at least one of information indicating whether or not there is an accompanying person or information indicating whether or not the user has luggage.

### (9)

The information processing apparatus according to any one of (1) to (8), in which the delivery object information includes at least one of information indicating a type of the delivery object, information related to a size of the delivery object, information related to a weight of the delivery object, or information related to a storage method of the delivery object.

### (10)

The information processing apparatus according to any one of (1) to (9), in which the delivery object information includes information indicating a current position of the delivery object.

### (11)

The information processing apparatus according to any one of (1) to (10), in which the generation unit generates receiving method information that enables the delivery object to be received earlier than a current delivery schedule by changing an action of the user.

### (12)

The information processing apparatus according to any one of (1) to (11), in which the generation unit generates a plurality of pieces of receiving method information corresponding to a plurality of receiving method candidates, and

the information processing apparatus further includes an output control unit that causes the plurality of pieces of receiving method information to be presented to the user.

### (13)

The information processing apparatus according to (12), in which the information processing apparatus further includes a communication unit that transmits the receiving method information corresponding to receiving method selected by the user from the plurality of pieces of receiving method information.

### (14)

The information processing apparatus according to any one of (1) to (13), in which the generation unit generates the receiving method information in a case where it is determined on a basis of the user information that it is difficult to perform reception by a currently arranged receiving method.

### (15)

The information processing apparatus according to any one of (1) to (14), in which the information processing apparatus further includes an output control unit that further causes an alert for guiding the user to be presented on a basis of the receiving method information.

### (16)

The information processing apparatus according to (15), in which, in a case where it is determined that the user has approached a receiving position indicated by the receiving method information, the output control unit causes the alert notifying that the user has approached the receiving position to be presented.

### (17)

The information processing apparatus according to (15) or (16), in which, in a case where it is determined that the user exists at a position different from a receiving position indicated by the receiving method information, the output control unit causes the alert notifying that the user exists at the position different from the receiving position to be presented.

### (18)

The information processing apparatus according to any one of (15) to (17), in which the alert includes route information to a receiving position indicated by the receiving method information.

### (19)

An information processing method. An information processing method including generating, by a processor, on a basis of delivery object information related to a delivery object that is to be delivered to a user and user information related to the user, receiving method information related to a receiving method of the delivery object.

### (20)

A program for causing a computer to achieve a function of generating, on a basis of delivery object information related to a delivery object that is to be delivered to a user and user information related to the user, receiving method information related to a receiving method of the delivery object.

### DESCRIPTION OF REFERENCE NUMERALS

1 user terminal

2 server

3 delivery company system

11 control unit

12 sensor unit

13 display unit

14 speaker

15 input unit

16 storage unit

17 communication unit

21 generation unit

23 adjustment control unit

25 output control unit

27 storage unit

29 communication unit

32 company server

34 delivery person terminal

1. An information processing apparatus comprising a generation unit that generates, on a basis of delivery object information related to a delivery object that is to be delivered to a user and user information related to the user, receiving method information related to a receiving method of the delivery object.

2. The information processing apparatus according to claim 1, wherein the receiving method information comprises receiving time information related to a time at which the user is able to receive the delivery object and receiving position information related to a position at which the user is able to receive the delivery object.

3. The information processing apparatus according to claim 2, wherein the generation unit generates the receiving position information by predicting a future position of the user on a basis of the user information.

4. The information processing apparatus according to claim 2, wherein the generation unit generates the receiving time information by performing prediction related to the time at which the user is able to receive the delivery object on a basis of the user information and the delivery object information.

5. The information processing apparatus according to claim 4, wherein the generation unit performs the prediction related to the time at which the user is able to receive the delivery object on a basis of information comprising at least one of information indicating a future position of the user or information indicating a future state of the user.

6. The information processing apparatus according to claim 4, wherein the generation unit performs the prediction related to the time at which the user is able to receive the delivery object on a basis of intended purpose information related to an intended purpose of the delivery object.

7. The information processing apparatus according to claim 1, wherein the user information comprises at least one of information indicating a current or future position of the user or information indicating a future state of the user.

8. The information processing apparatus according to claim 1, wherein the user information comprises at least one of information indicating whether or not there is an accompanying person or information indicating whether or not the user has luggage.

9. The information processing apparatus according to claim 1, wherein the delivery object information comprises at least one of information indicating a type of the delivery object, information related to a size of the delivery object, information related to a weight of the delivery object, or information related to a storage method of the delivery object.

10. The information processing apparatus according to claim 1, wherein the delivery object information comprises information indicating a current position of the delivery object.

11. The information processing apparatus according to claim 1, wherein the generation unit generates receiving method information that enables the delivery object to be received earlier than a current delivery schedule by changing an action of the user.

12. The information processing apparatus according to claim 1, wherein
the generation unit generates a plurality of pieces of receiving method information corresponding to a plurality of receiving method candidates, and
the information processing apparatus further comprises an output control unit that causes the plurality of pieces of receiving method information to be presented to the user.

13. The information processing apparatus according to claim 12, wherein the information processing apparatus further comprises a communication unit that transmits the receiving method information corresponding to receiving method selected by the user from the plurality of pieces of receiving method information.

14. The information processing apparatus according to claim 1, wherein the generation unit generates the receiving method information in a case where it is determined on a basis of the user information that it is difficult to perform reception by a currently arranged receiving method.

15. The information processing apparatus according to claim 1, wherein the information processing apparatus further comprises an output control unit that further causes an alert for guiding the user to be presented on a basis of the receiving method information.

16. The information processing apparatus according to claim 15, wherein, in a case where it is determined that the user has approached a receiving position indicated by the receiving method information, the output control unit causes the alert notifying that the user has approached the receiving position to be presented.

17. The information processing apparatus according to claim 15, wherein, in a case where it is determined that the user exists at a position different from a receiving position indicated by the receiving method information, the output control unit causes the alert notifying that the user exists at the position different from the receiving position to be presented.

18. The information processing apparatus according to claim 15, wherein the alert comprises route information to a receiving position indicated by the receiving method information.

19. An information processing method.
An information processing method comprising generating, by a processor, on a basis of delivery object information related to a delivery object that is to be delivered to a user and user information related to the user, receiving method information related to a receiving method of the delivery object.

20. A program for causing a computer to achieve a function of generating, on a basis of delivery object information related to a delivery object that is to be delivered to a user and user information related to the user, receiving method information related to a receiving method of the delivery object.
